(19) United States
(12) Patent Application Publication
(10) Pub. No.: US 2016/0229148 A1
(43) Pub. Date: Aug. 11, 2016

(54) LANDING GEAR BOX MADE OF COMPOSITE MATERIAL PANELS

(71) Applicant: DAHER AEROSPACE, Saint Julien De Chedon (FR)

(72) Inventors: Romain LEFRANCOIS, Creteil (FR); Georges FILIPPI, Merignac (FR); Mathieu HOTTIN, Civray De Touraine (FR); François LEMOINE, Nantes (FR)

(73) Assignee: DAHER AEROSPACE, Saint Julien De Chedon (FR)

(21) Appl. No.: 15/131,091

(22) Filed: Apr. 18, 2016

Related U.S. Application Data
(62) Division of application No. 13/508,323, filed on Jul. 23, 2012.

(30) Foreign Application Priority Data
Nov. 18, 2009 (FR) 09/05542

(51) Int. Cl. B32B 1/02; B32B 5/02; B32B 7/08; B64C 25/00; B32B 3/28

(52) U.S. Cl. CPC B32B 1/02; B64C 25/001; B32B 3/28; B32B 7/08; B32B 5/02; B32B 2260/021; B32B 2260/046; B32B 2605/18

(57) ABSTRACT

A landing gear box is made of composite material panels comprising a skin made of composite material and having two opposite general sides, and first stiffeners extending over one of the sides of the skin. It is characterised in that it comprises additional stiffeners that are arranged on the side of the skin opposite that bearing the first stiffeners, and which extend in a direction distinct from that of the first stiffeners. The skin and the stiffeners arranged on each side are preferably made integral by co-moulding.

### CROSS-REFERENCES TO RELATED APPLICATIONS

This application is a divisional of U.S. patent application Ser. No. 13/508,323, filed May 4, 2012, which is the National Stage of PCT/FR2010/052440, filed Nov. 17, 2010, and claims priority to French Patent Application No. 09/05542, filed Nov. 18, 2009, the disclosures of all of which are incorporated herein by reference in their entirety.

### TECHNICAL FIELD

The invention relates to a landing gear box made of composite material panels comprising a skin made of composite material and elements that reinforce the rigidity of the panel, called stiffeners.

### SUMMARY

Such flat or curved body panels are commonly used in the area of aeronautics, particularly for making aircraft fuselages, because they address the requirements of both rigidity and weight saving.

Composite material means a reinforcing material made from fibres such as glass, carbon, aramid or other fibres, which takes the form of strands or woven or non-woven webs, the reinforcement material being impregnated with thermoplastic or thermosetting material.

The stiffeners are elements that are integrated into or added to one of the sides of the skin of the panel. These stiffeners may extend in only one direction of the panel, or in two directions and cross each other.

In the type of architecture with stiffeners in two directions, the first stiffeners that extend in the first direction are co-polymerised with the skin during a moulding operation, then other stiffeners designed to extend in the second direction are fastened to the first stiffeners. Fastening is generally achieved by forming cavities in the first stiffeners, by placing the second stiffeners in those cavities and by making them integral at the place of crossing by appropriate fastening means of the clipping means type.

However, such manufacturing requires drilling, assembly operations and necessarily operations to inspect all the fastening, and needs time and resources in the implementation process, which it is always desirable to reduce in order to save production costs.

Further, the fastening means, which are essentially made of metal, add to the weight of the panels, which does not make fuselages lighter and does not help reduce material costs.

Lastly, industrial manufacturing capacities limit the possibility of making stiffener crossings other than orthogonally for a competitive cost.

The invention is thus aimed at offering a composite panel with stiffeners arranged in at least two directions and succeeding in limiting or even reducing its weight and simplifying its manufacturing process, without affecting the mechanical rigidity of the structure.

According to the invention, the panel made of composite material comprises a skin made of composite material that has two opposite general sides, and first stiffeners extending over one of the sides of the skin in at least one direction, for example in the same direction as regards all these first stiffeners, the panel being characterised in that it comprises additional stiffeners that are arranged on the side of the skin opposite that bearing the first stiffeners, which extend in a direction distinct from that of the first stiffeners.

With the reinforcement on both opposite sites, the panel of the invention provides a structure that is as rigid as in the prior art, and simplifies its manufacture by doing away with the need to make recessed slots in the first stiffeners and the need for fastening means.

Preferably, the first stiffeners and the additional stiffeners are manufactured simultaneously by moulding them respectively on the two opposite sides of the skin.

Thanks to manufacturing by moulding, the stiffeners can be made easily on two opposite sides of the skin. Besides, the skin and the stiffeners are made integral robustly and lastingly, the panel forming a single-piece body.

That solution further makes it possible to rigidify the panel, firstly without adding complementary pieces and therefore leading to no additional weight, and secondly without altering the stiffeners, which thus retain all their integrity and their mechanical properties.

However, the skin and the first stiffeners may be achieved by moulding, whereas the additional stiffeners may be added on by gluing or riveting.

The panel and all the stiffeners are particularly moulded by means of co-injection or co-moulding. Co-injection consists in a single operation involving the making of all the parts of the panel (skin and stiffeners) by placing the reinforcing fibres in a mould and injecting the plastic material. Co-moulding consists in moulding each part of the panel independently and assembling the whole by polymerising in a mould adapted to the shape of the entire panel.

Seams of fibre bonds obtained during the panel moulding manufacturing operation can be placed at the surfaces on which the stiffeners are made integral with the skin.

Even though the panel that is thus made by moulding makes the stiffeners fully integral with the skin, rivets may be added that go through the skin and the stiffeners at the surface on which they are made integral.

According to one characteristic, the first stiffeners and the additional stiffeners are placed so as to be directed angularly in relation to each other, preferably orthogonally. The stiffeners directed in distinct directions are not on the same side, and it is easy to place them in any direction for a low cost.

Each stiffener comprises a core and at least one base, the stiffener being associated with the skin over all or most of its length via its core and/or its base or bases.

Advantageously, the stiffeners may have a profile with a Ω, C, U, T, Z, I, L, or J section, but not limited to those.

The stiffeners are made of composite material, preferably identical to the composite material of the skin, particularly of epoxy, phenolic or poly-bismaleimide (BMI) or other plastic, in which long or continuous, woven or non-woven fibres of the glass, carbon or aramid fibre type are embedded.

The composite panel is designed particularly to be used in the walls of ships, trains or in the aeronautics industry, particularly in aircraft fuselages and specifically in the landing gear area and/or the central wing box area.

The panel according to the invention can be used advantageously in the landing gear area of an aircraft that forms a cavity in relation to the outer surface of the aircraft and is thus not subjected to aerodynamic constraints. Indeed, that area is perfectly adapted for receiving a panel assembly according to the invention, without the stiffeners that project out of the composite skin constituting an obstacle to the air flow licking the outer surface of the fuselage, outside the cavity.

The invention also relates to a method for manufacturing a composite material panel comprising a skin and stiffeners on two opposite sides of the skin, characterised in that it comprises a moulding stage that ensures, upon removal from the mould, that the skin is fully integral with the stiffeners. Moulding may consist in co-injection or co-moulding.

### BRIEF DESCRIPTION OF THE DRAWINGS

This invention will now be described with the help of examples that merely illustrate, but are not limitative in any way, the scope of the invention by reference to the accompanying drawings, wherein:

FIG. 1 is a partial perspective view of a panel according to the invention;

FIG. 2 is a sectional view of FIG. 1 along one of the larger dimensions of the panel;

FIG. 3 is another sectional view of FIG. 1 along the other larger dimension of the panel;

FIG. 4 is a partial perspective view of an alternative embodiment of the panel according to the invention;

FIG. 5 is a partial schematic and sectional view of the front and middle part of an aircraft showing the landing gear area and the area of the central wing box;

FIG. 6 is an enlarged view of the landing gear area of FIG. 5.

### DETAILED DESCRIPTION

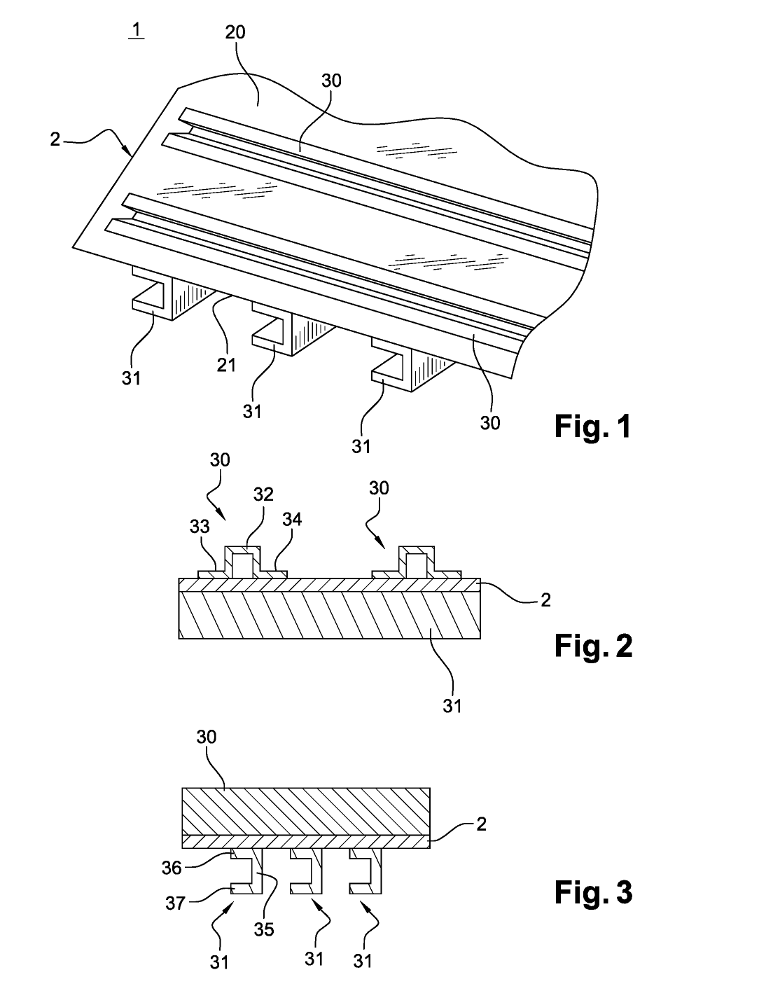

FIG. 1 illustrates a composite panel 1 according to the invention. The combination of several such panels may for example make it possible to form part of aircraft fuselage as illustrated schematically in FIG. 5, particularly in the landing gear area 4 or the central wing box area 6.

The composite panel 1 comprises a skin 2 made of composite material and a plurality of structuring elements 30, 31 that contribute to the rigidity and strength of the panel.

The composite skin 2 is made up of plastic material of the epoxy resin, phenolic or BMI type, in which reinforcing fibres such as glass fibres, carbon fibres or aramid fibres of the Kevlar® are type are embedded. The fibres take the form of long or short fibres, woven or non-woven.

The thickness of the skin is small in relation to its other dimensions, namely length and width.

The skin has two opposite general sides 20 and 21 that each extend along the largest dimensions. Its shape may be flat or curved, even doubly curved, and may comprise local level differences in its thickness.

The structuring elements 30, 31 or stiffeners contribute to the structural rigidity of the panel and make the panel stronger in respect of constraints applied transversal to the general sides 20 and 21 of the skin.

According to the invention, the first stiffeners 30 are arranged on the first general side 20 of the skin, whereas additional stiffeners 31 are placed on the second opposite side 21 of the skin.

The stiffeners 30 and 31 are oblong in shape, their larger dimension (length) extending in parallel or angularly in respect of one of the larger dimensions of the skin 2.

Further, the first stiffeners 30 are not placed parallel to the additional stiffeners 31 but are angularly oriented in relation to them, for example orthogonally as illustrated in FIG. 1. The first stiffeners are preferably directed in the same direction but may have distinct directions, without however crossing each other.

The distinct angular orientation between the first stiffeners and second stiffeners on the opposite side contributes to the mechanical strength required of the panel.

Stiffeners 30 and 31 are hollow and may take several shapes, for instance Ω, C, T, Z or I shapes etc.

The stiffeners have a core and at least one base, and are joined to the skin through their core or their base or bases, over all or most of their length. The shape of a stiffener along its length follows the general shape of the skin, namely flat, curved or uneven. Further, the profile of a stiffener can vary over its length.

The example of stiffeners illustrated in FIG. 1 have a Ω-shaped section as regards the first stiffeners 30 of the side 20 of the skin and as illustrated in the sectional view of FIG. 2, whereas the additional stiffeners 31 on the opposite side 21 of the skin have a C-shaped section (sectional view of FIG. 3).

The first stiffeners 30 with a Ω-shaped section each comprise a core 32 with a U-shaped section, and two bases 33 and 34 that are substantially perpendicular to the branches of the U and extend in two opposite directions, the stiffeners being integral with the side 20 of the skin 2 via the bases 33 and 34.

The additional C-shaped stiffeners 31 each have a core 35 and two opposite bases 36 and 37 that oppose each other, the stiffeners being integral with the side 31 of the skin 2 via one of the bases 36.

The stiffeners 30 and 31 are made of composite material, preferably identical to that of the skin 2. In the invention, they are made integral with the mould by moulding.

Two moulding alternatives are envisaged, by co-injection and by co-moulding.

Co-injection consists in introducing fibres, for example in the form of a fabric, in a mould in which all the shapes are drawn (skin and stiffeners), and injecting plastic material. Upon removal from the mould, the skin and stiffeners make up a single-piece body in a single operation on the two opposite sides of the skin 2.

Co-moulding consists in moulding the pieces that form the skin and stiffeners independently, then introducing these pieces in a mould to polymerise them so as to assemble them. When removed from the mould, they form a single whole.

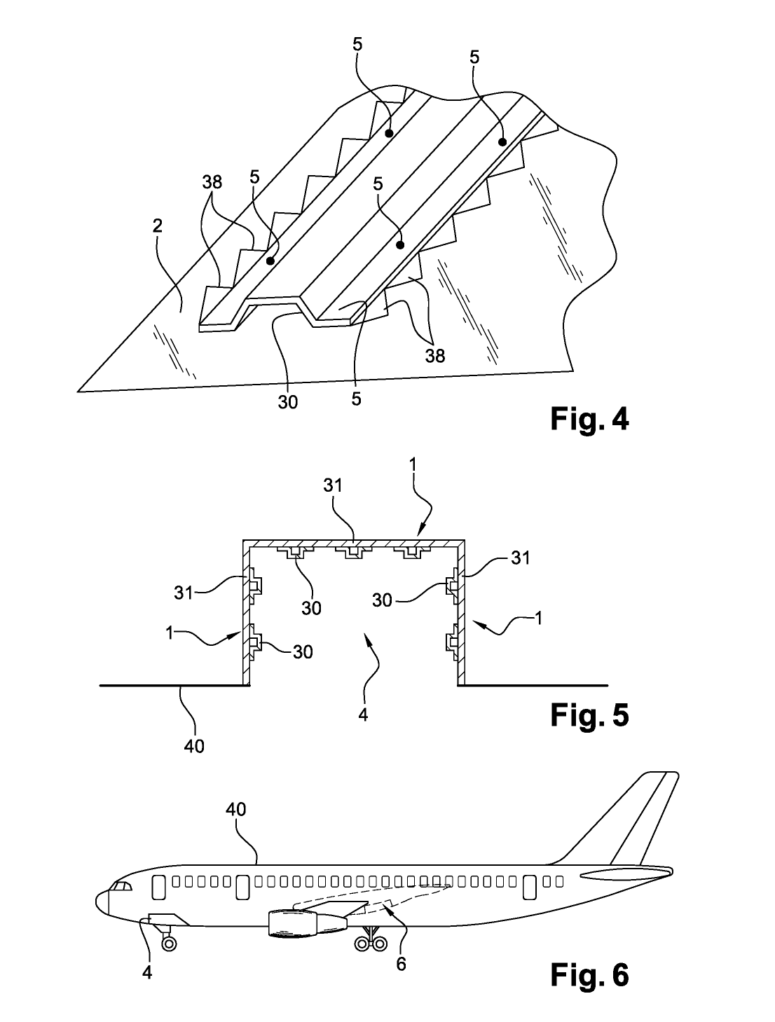

It may be envisaged that as illustrated in FIG. 4, fibre bonds are added at the bonding zones between the skin and the stiffeners to make up, after moulding, the seams 38 that further make the integration stronger.

Stiffeners that are hollow are made from so-called core pieces, the outer shape of which makes it possible to make the casing of the stiffeners. After moulding, the cores are extracted to define the hollow area of the stiffeners. A core may for example be made up of a balloon made of soft inflatable material or material that can dilate or contract with temperature changes, particularly during or after the composite material of the panel is polymerised.

FIG. 4 illustrates an additional alternative of a panel comprising rivets 5 that go through the skin and the stiffeners at the surface on which they are made integral. The rivets are added after the panel is made by moulding.

FIG. 6 illustrates a partial schematic view of an aircraft showing the landing gear area 4. This is a cavity made in the underside 40 of the aircraft. The interior of the cavity is not subjected to aerodynamic constraints, and the association of a plurality of panels according to the invention 1 is particularly suitable for making up the wall of that cavity.

Thus, the stiffeners 30 and 31 are placed on each side of the cavity to make the wall rigid, the additional C-shaped stiffeners 31 being for example on the outer side of the cavity and turned towards the inside of the aircraft, whereas the first Ω-shaped stiffeners 30 project out into the inside of the cavity without leading to any aerodynamics constraint because it is not in direct contact with the outside air.

1. A landing gear box for an aircraft the walls of said landing gear box being made with body panels made of composite material, comprising a skin made of composite material, made of a plastic material reinforced by continuous fibers, that has two opposite general sides, and first stiffeners extending over one of the sides of the skin in one direction, and comprising additional stiffeners that are arranged on the side of the skin opposite that bearing the first stiffeners, and which extend in a direction orthogonal to that of the first stiffeners, and wherein the stiffeners are made of composite material identical to the composite material of the skin.

2. The landing gear box according to claim 1, wherein the fibers are continuous, woven or non-woven fibres of glass, carbon or aramid type.

3. The landing gear box according to claim 1, wherein each stiffener has a core and at least one base, the stiffener being joined to the skin through its core or its base or bases, over all or most of its length.

4. The landing gear box according to claim 1, wherein the stiffeners have a Ω, C, T, Z I, L or J-shaped section.

5. The landing gear box according to claim 1, wherein the stiffeners are made integral with the skin.

6. The landing gear box according to claim 1, wherein the body panel includes rivets that go through the skin and the stiffeners at the surface on which they are made integral.
